(19) United States
(12) Patent Application Publication
(10) Pub. No.: US 2018/0355278 A1
(43) Pub. Date: Dec. 13, 2018

(54) Methods for Extraction of Essential Oils

(71) Applicant: Peak Research Group, LLC, Rowlett, TX (US)

(72) Inventors: Jordan Matthew BAUMHARDT, Dallas, TX (US); Marcus Delane GRAYSON, Garland, TX (US)

(21) Appl. No.: 15/621,283

(22) Filed: Jun. 13, 2017

(51) Int. Cl. C11B 9/02; B01D 3/10

(52) U.S. Cl. CPC C11B 9/025; G01N 2001/4061; B01D 3/10; C11B 9/027

(57) ABSTRACT

The disclosure relates to a method for extraction of plant essential oils from plant material using a water/water miscible extraction solvent or a water/hydrophobic extraction medium/water mixture as an extraction mixture.

### FIELD OF INVENTION

The present disclosure relates to extraction of essential oils from plants.

### BACKGROUND OF INVENTION

Plant essential oils are known to have many beneficial properties. While one may take advantage of the beneficial properties of plant essential oils by direct use of the plant material containing these oils, in order to take advantage of these beneficial properties of plant essential oils, it is desirable to be able to obtain extracted plant essential oils from plant materials. Extraction of plant essential oils allows for direct use of the essential oils and for use of essential oils in other formulations without the need to incorporate the plant material itself.

Generally, plant essential oils are varied in structure and chemical nature, depending on the type of plant and the desired oil to be extracted. But, in general many desired plant essential oils are or contain terpene or terpenoid like molecules and it is often the terpene or terpenoid like components of plant essential oils that contribute to the desired benefit of the plant essential oil.

There are a number of known methods for isolating essential oils and the terpene and terpenoid like compounds of plant essential oil from plant material. These include a variety of extraction methods in which the plant material containing the desired essential oil is placed in contact with a solvent capable of dissolving the essential oils from the plant material. Plant essential oils and their terpene and terpenoid like components tend to be small hydrocarbon molecules that, while they may have some polar functionality, are insoluble in water alone. So many of the known extraction methods do not use water as an extraction solvent. Common organic solvents are often used for essential oil extraction. This includes solvents such as methanol, isopropanol, dichloromethane, acetonitrile, ethyl acetate, hexane and other similar solvents. But, plant materials contain a number of other components, besides the desired essential oils, that are readily soluble in these types of common organic solvents. This leads to a number of undesired results including the extraction of unwanted extraction byproducts, decreasing the purity of the essential oils extracted, causing the crude essential oil extract to have undesired properties, creating the need for further purification of the essential oil extract, and introducing chemical components that may cause degradation of the essential oil extract.

Another known method of removing essential oils from plant material is by steam distillation. Because plant essential oils and their terpene and terpenoid like components typically are small hydrocarbon molecules, they generally have boiling points that make them amenable to removal from plant materials by steam distillation. However, steam distillation is generally an intensive and time consuming process with relatively low yields when compared to other methods of extracting plant essential oils.

Another known method for extraction of plant essential oils is extraction by super critical carbon dioxide. However, this extraction method suffers from a number of drawbacks including relatively large costs for the equipment needed, the need for specialized training to safely and correctly operate the equipment used in the process, and that fact that this method often produces a lower quality crude product when compared to other methods.

### SUMMARY OF INVENTION

According to one illustrative embodiment, plant essential oils are extracted from plant material by a method utilizing a solution of water and a water miscible solvent. The plant matter from which the essential oils are to be extracted is exposed to the water/water miscible solvent solution and agitated for a time long enough to extract the plant essential oils. Optionally, the resulting mixture may be heated or cooled to promote essential oil extraction and/or increase the quality of the crude essential oil extract. After sufficient extraction time, the plant material is removed from the extraction mixture. The resulting solution containing the water, the water miscible solvent, the essential oils, and possible undesired extraction products is phase separated by the addition of a salt, a carbohydrate, or a mixture of salts and/or carbohydrates. Sufficient salts and/or carbohydrates are added to the extraction mixture until the water and water miscible organic solvent phase separate. The water layer is removed from the remaining organic solvent/essential oil extract. The organic solvent is removed to yield crude essential oil extract.

According to another illustrative embodiment, plant essential oils are extracted from plant material by a method utilizing a high boiling point, hydrophobic extraction medium, such as a lipid. The extraction medium should have a boiling point that is greater than the boiling point of the essential oils to be extracted. Plant materials prepared for extraction are contacted with a mixture of the hydrophobic extraction medium and water. Optionally, the mixture may be agitated and/or heated to promote essential oil extraction. Optionally, a water-soluble additive, such a sugar, may be added to the water to improve the quality of the extracted essential oils. After sufficient time for essential oil extraction, the hydrophobic extraction medium layer, which contains the crude essential oil extract, is separated from the plant material and water layer. The extracted essential oils are separated from the extraction medium by vacuum distillation. Optionally, the extracted essential oils may be separated from the extraction medium by other purification methods, such as chromatography, or by multi step purification, such as chromatography followed by distillation or vice versa. In addition, the crude essential oil extract may optionally be further purified by known purification methods, such as chromatography. Other methods are presented.

### DETAILED DESCRIPTION OF THE INVENTION

In one illustrative embodiment, a method of essential oil extraction from plant material includes the steps of contacting the plant material with a mixture of water and a water miscible solvent, agitating the resulting mixture for a period of time, inducing phase separation of the water and water miscible solvent by addition of salts and/or carbohydrates; isolating the water miscible solvent, and evaporating the water miscible solvent to produce crude plant essential oil extract.

The use of a water/water miscible solvent solution results in the use of an extraction solution that is suitable for extracting essential oils from plants, but also minimizes the amount of undesired extraction byproducts that may also be extracted from the plants. Typically, plant essential oils do not have strong solubility in water alone and often are not water-soluble at all. So water alone is a poor extraction solvent. On the other hand, plant essential oils typically have much greater solubility in common organic solvents, including both hydrophobic and hydrophilic organic solvents, such as methanol, acetonitrile, ethyl acetate, dichloromethane, etc. However, use of common organic solvents alone often results in extraction of undesired byproducts. Use of a solution of water and a water miscible organic solvent as an extraction solvent addresses both of these issues. Use of a solution of water and water miscible solvent mixture as the extraction solvent results in a solvent that is strong enough to extract plant essential oils, but with the reduced potential to extract undesired byproducts.

In addition, the use of a mixture of water and a water miscible solvent in the disclosed method allows for adjustment of the solvating strength of the extraction solution. While the detailed description of embodiments describe certain ratios of the water to the water miscible solvent in the extraction solution, the methods are not limited to any particular ratio of water to water miscible solvent. The ratio of water to water miscible solvent may be between 1:99 to 99:1 by volume. Preferred ratios of water to water miscible solvent range from 25:75 to 75:25 by volume, and even more an even more preferred range of water to water miscible solvent is 40:60 to 60:40 by volume. Higher or lesser ratios of water to water miscible solvent may be used, which provides the advantage of being able to adjust the strength of the extraction solution so that the extraction solution strength may be adjusted to target the extraction of desired essential oils while avoiding extraction of unwanted byproducts.

The water miscible solvent may be any number of water miscible solvents. Non-limiting examples of suitable water miscible solvents include acetic acid, acetone, acetonitrile, t-butyl alcohol, diethylene glycol dimethyl ether, dimethylformamide, dimethyl sulfoxide, 1,4-dioxane, ethanol, ethylene glycol, glycerin, methanol, 1-propanol, 2-propanol, pyridine, and combinations of these. Given the variability in extraction conditions, the methods are not limited to any particular water miscible solvent. Instead the water miscible solvent may be varied to achieve desirable crude extraction products. The choice of the appropriate water miscible solvent may be driven by considerations of the particular essential oil extraction to be performed. Such considerations include, but are not limited to, the type of plants from which essential oils are to be extracted, the type of plant material used for the extraction such as leaves, stems, etc., the solubility of the essential oils in the water miscible solvent, the desired temperature of the extraction, the extent of water miscibility with the water miscible solvent, the solubility of undesired extraction products in the water miscible solvent, the solubility of salts and/or carbohydrates in the water miscible solvent, the miscibility of the water miscible solvent in a water/salt or water/carbohydrate solution, the desired pH of the extraction mixture, etc. Preferred water miscible solvents include low boiling point, polar, small molecular weight water miscible solvents such as: methanol, isopropanol, 1-propanol, ethanol, acetonitrile, acetone, and other like solvents. Relatively low boiling point solvents are preferred because this allows for eventual removal of the water miscible solvent at relatively lower temperatures and prevents overheating of the concentrated essential oil product and resulting degradation that can occur under these conditions. In addition, use of higher boiling point solvents may lead to contamination of the crude essential oil extraction product with the water miscible solvent, which may result in the need to further purify the essential oil extraction product so that it is suitably pure for its intended use.

Even though the use of a water/water miscible solvent mixture reduces the amount and number of byproducts extracted from the plant material, some byproducts are typically still extracted into the extraction solution. These typically tend to be hydrophilic molecules with ionic and/or polar functionality that causes these byproducts to be soluble in water alone. On the other hand, the desired essential oils are poorly soluble in water alone. The addition of a salt and/or a carbohydrate to the extraction mixture after the initial extraction period takes advantage of this solubility difference. The addition of salt and/or carbohydrates to the extraction mixture causes the water and the water miscible layer to phase separate. The salt or carbohydrate has relatively high water solubility and low solubility in the water miscible solvent. As the concentration of salt or carbohydrate in the extraction solution increases the water and water miscible solvent become less miscible. Increasing the salt or carbohydrate concentration results in phase separation of the water and water miscible solvent where the salt or carbohydrate is dissolved in the water layer and the extracted essential oil is dissolved in the water miscible solvent layer. The hydrophilic extraction byproducts typically remain in the water layer because they are more soluble in the water than they are in the water miscible solvent. In this manner, the undesired byproducts of the extraction with the water/water miscible solvent may be quickly and efficiently separated from the desired essential oil extract.

The salt and/or carbohydrate used in the disclosed embodiments may be any number of suitable salts or carbohydrates. In addition, the methods may use a salt alone, a carbohydrate alone, a combination of salts, a combination of carbohydrates, or a combination of salt and carbohydrate. Salts may be monovalent or multivalent water soluble salts. Typically, suitable salts are water soluble salts containing an alkaline metal anion, alkaline earth metal anion, or a polyatomic anion. But other water soluble salts with other anions may also be used. Typically, suitable salts are those containing a halide cation, such as chloride or bromide, or a polyatomic cation, such as nitrate, sulfate, or phosphate. But other water soluble salts with other cations may also be used. Sodium chloride and sodium iodide being two examples of preferred alkali metal/halide salts.

Carbohydrates may be water soluble saccharides, disaccharides, polysaccharides, or large water soluble carbohydrates. Examples of suitable carbohydrates for the disclosed method include: glucose, sucrose, fructose, galactose, maltose, lactose, glycogen, water soluble starches, and other water soluble saccharide based polymers. Glucose and sucrose being two examples of preferred carbohydrates for use in the extraction method.

The amount of salt and/or carbohydrate used in the extraction method may vary depending upon the particular conditions of the extraction, such as the type of plant being extracted, the nature of the extraction solvent, etc. However, sufficient salt and/or carbohydrate should be added so that the water/waters miscible solvent extraction solution is forced to phase separate in to a water layer and a water miscible solvent layer. This facilitates removal of water and water soluble byproducts from the essential oil extracts, which remain in the water miscible solvent. The amount of salt or carbohydrate needed to induce phase separation depends on many factors such as the particular water miscible solvent used in the extraction, the temperature of the extraction mixture, the ratio of water to water miscible solvent in the extraction mixture, and the concentration of extraction products in the extraction mixture. It is preferred that the concentration of salt or carbohydrate be at or near its saturation point relative to the amount of water in the extraction mixture. But, the concentrations of salt or carbohydrate, for particular extraction mixtures, may be lower than the saturation point relative to the amount of water in the extraction mixture, in this case, salt and/or carbohydrate concentrations below the saturation point relative to the amount of water in the extraction mixture may be preferred.

Even though both salts and carbohydrates may be used in the disclosed method, carbohydrates are preferred over salts. Salts, generally, have a greater potential to react with essential oil extracts or to catalyze reactions that degrade essential oil extracts, when compared to carbohydrates.

The disclosed method may optionally involve heating the extraction mixture during any step or as an additional step. Heating the extraction mixture promotes solubility of desired essential oil extracts in the extraction solvent thereby potentially increasing the yield of essential oil able to be extracted and/or reducing the time needed for extraction. The extraction mixture may be heated up to the boiling point of the extraction solvent. However, lower temperatures are generally preferred over higher temperatures. While heat promotes extraction of desired products, heat may also promote extraction of byproducts and/or promote degradation of the essential oils that are extracted, both resulting in a lower quality crude extraction product.

In another illustrative embodiment, plant essential oils are extracted from plant material by a method utilizing a high boiling point, hydrophobic extraction medium, such as a lipid. Prepared plant materials to be extracted are placed in contact with a mixture of the hydrophobic extraction medium and water. After sufficient time for extraction, plant material and water are removed from the extraction mixture. The remaining extraction mixture containing the hydrophobic extraction medium and the extracted essential oils is then subjected to distillation to remove the essential oil extraction product from the higher boiling point hydrophobic extraction medium.

A number of possible mediums may be used as the hydrophobic extraction medium of the disclosed method. Generally suitable mediums will be hydrophobic oily liquids with high boiling points so that the boiling point of the hydrophobic extraction medium is substantially greater than the boiling point of the essential oil extraction products. A boiling point difference between the hydrophobic extraction medium and the essential oil extraction product of 50° C. (at atmospheric pressure) or greater is preferred. But lower boiling point difference may be used. Typically, monoterpene components of plant essential oils have a boiling point less than 100° C. at atmospheric pressure and other larger terpene, terpenoid type, and other essential oils components may typically have boiling points between 100° C. and 230° C., at atmospheric pressure. The essential oil extraction product must be removed from the hydrophobic extraction medium to obtain the crude essential oil extraction product. Because of the nature of the hydrophobic extraction medium and the essential oil extraction product, one of the more efficient manners of removing the crude essential oil extraction product from the hydrophobic extraction medium is by vacuum distillation, in which the lower boiling essential oil extraction product is removed from the hydrophobic extraction medium. A greater difference between the boiling point of the essential oil extraction product and the hydrophobic extraction medium results in more effective and efficient vacuum distillation. The difference between the boiling point of the hydrophobic extraction medium and the essential oil extract is preferably large enough so that the essential oil extract may be removed from the hydrophobic extraction medium by vacuum distillation with little evaporation of the hydrophobic extraction medium.

Generally, hydrophobic oily liquids are useful as hydrophobic extraction mediums for plant essential oils. Plant essential oils are typically more soluble in hydrophobic mediums than they are in aqueous mediums. In addition, a concern in the extraction of essential oils from plants is the undesired extraction of byproducts. Typically many of the possible unwanted byproducts that could be extracted from plant material are either readily soluble in water or in common organic solvents typically used for other types of extractions. For example, undesired byproducts are typically soluble in solvents such as ethyl acetate, dichloromethane, hexane, and similar solvents. But, many of the byproducts that would be extracted by such common organic solvents have little to no solubility in hydrophobic oily liquids. At the same time, the desired essential oil extract is soluble in hydrophobic oily liquids. This makes hydrophobic oily liquids particularly useful as extraction mediums that are able to extract the desired essential oil extracts while minimizing byproduct extraction.

Lipids are an example of a suitable hydrophobic extraction medium for use in the disclosed extraction method. Generally, lipids refer to a class of molecules that an insoluble in water and have a large ratio of nonpolar hydrocarbons. Commonly lipids have a nonpolar aliphatic unbranched or branched chains of at least more than 8 carbons and often times many more carbons in length, which results in their limited solubility in water and their hydrophobic nature. General examples of lipids include fats, fatty acids, waxes, and oils. Some lipids have a polar and/or ionic functional group at the end of a nonpolar aliphatic chain. An example of this type of lipid are soaps and detergents which are generally characterized by a polar ionic group, such as a carboxylic acid or an ammonium group, on the end of a long nonpolar aliphatic chain. While soaps or detergent type lipids typically contain a polar ionic group, these compounds are still very hydrophobic in nature due to the large non polar hydrocarbon portion of these molecules. But, the polar ionic component may interact in some manner with other polar functional groups or polar solvents, such as water. Other lipids, have functional groups that are much less polar and/or non ionic and are therefore much less likely to interact with water or polar or ionic compounds. These include fats and oils which are esters of carboxylic acid varieties of soaps.

In the example below of this embodiment, the hydrophobic extraction medium was vegetable oil, but other suitable hydrophobic extraction mediums could be used. In general, fats and oils are particularly useful as the hydrophobic extraction medium. Fats and oils are typically triglycerides, which are triesters of fatty acids with glycerol. Because the carboxy group of fats and oils is esterified, fats and oils are highly hydrophobic, even when compared to other lipids such as soaps and detergents, and are much less likely to interact with water or polar or ionic compounds than other lipids. In the disclosed method, this is preferred because the desired essential oil extracts are soluble in fats and oils but polar and/or ionic byproducts are not. Use of a lipid that is a soap or detergent, for example, would be suitable for use in the disclosed extraction method but is less preferred because while a soap would be able to dissolve the desired essential oil, a soap may also dissolve byproducts and/or cause unwanted interactions between the essential oils and the aqueous component of the extraction mixture.

Use of fats and oils are also preferred because of the relatively low melting points. Generally, fats are solid triglycerides that are solid at room temperature, but that melt at relatively low temperatures. So that they can be used as a hydrophobic extraction medium if heated slightly. Oils are even more preferred for use a hydrophobic extraction medium because oils generally are triglycerides that are liquid at room temperature, so no heating is required to use an oil as a hydrophobic extraction medium.

Fats and oils are also preferred lipids for use as a hydrophobic extraction medium because many fats and oils are readily available in large quantities. In addition, many of the available fats and oils are largely intended for use in cooking. Because of this, they are purified so that they are suitable for use in applications involving human consumption or application, which relieves the concern of adding unwanted or toxic impurities into the essential oil extract by using a hydrophobic extraction medium that might be contaminated with unwanted or toxic impurities.

Examples of suitable oils and fats for use in the disclosed method as a hydrophobic extraction medium include vegetable oil, safflower oil, peanut oil, olive oil, lard, olive oil, coconut oil, palm oil, corn oil, etc.

The disclosed methods of extraction using a hydrophobic extraction medium may optionally include agitation of the extraction mixture. This may be an additional step in a method or agitation during any step in which the plant material and hydrophobic extraction medium are in contact. While agitation promotes extraction by increasing extraction medium flow over and around the plant material, excess agitation of triglycerides in the presence of water can cause hydrolysis of the esters of the triglycerides. The hydrolysis of the triglyceride esters produces glycerin derivatives and soap or detergent like fatty acids. Both of which can negatively affect the quality of the essential oil extraction product by causing the extraction of byproducts, and/or increasing interactions between the essential oil extraction product and water. Hydrolysis of triglycerides also decreases the efficiency of extraction method. In addition, excessive agitation of the hydrophobic extraction medium in contact with water causes reverse micelle formation. Reverse micelle formation occurs when lipid molecules orient in so that the polar or ionic ends of the lipid molecules are aggregated together. Byproducts that are typically water soluble and insoluble in the hydrophobic extraction medium, may be trapped within the aggregations of the polar or ionic ends of the lipid molecules, are therefore solubilized into the hydrophobic extraction medium. This leads to the extraction of undesired byproducts into the hydrophobic extraction medium.

Generally, hand mixing the extraction mixture with a spoon or ladle does not cause excessive triglyceride hydrolysis. But, vigorous mixing with a magnetic stir bar and stir plate results in significant triglyceride hydrolysis and/or reverse micelle formation. Typically, stirring with magnetic stir plate and stir bar above 125 rpm is not preferred because this leads to excessive triglyceride hydrolysis and/or reverse micelle formation.

The addition of water into the extraction mixture in the disclosed method provides several advantages. For example, while plant essential oils may be extracted with a hydrophobic extraction medium alone, the addition of water to the extraction mixture increases the volume of the extraction mixture. Additional extraction mixture volume results in better wetting of the plant material and increases the contact between the extraction mixture and the plant material, both of which increase extraction efficiency and/or reduce the time needed for extraction. In addition, water that is added into the extraction mixture is easily separated from the hydrophobic extraction medium and the essential oil extract because water is not miscible or soluble with these components of the extraction mixture. Without the addition of water to the extraction mixture, it becomes necessary to increase the volume of hydrophobic extraction medium used in the extraction, which is undesirable because the hydrophobic extraction medium cannot be removed from the essential oil extract by simple phase separation, like water may be. In addition, the use of water in the extraction mixture allows for water soluble additives to be added to the extraction mixture which can be used to promote extraction efficiency, reduce extraction of byproducts, and reduce degradation of essential oil extracts during the extraction process.

While the detailed description of embodiments describes certain ratios of the water to the hydrophobic extraction medium in the extraction solution, the method is not limited to any particular ratio of water to hydrophobic extraction medium. The ratio of water to hydrophobic extraction medium may be between 1:99 to 99:1 by volume. Preferred ratios of water to hydrophobic extraction medium range from 25:75 to 75:25 by volume, and even more an even more preferred range of water to hydrophobic extraction medium is 40:60 to 60:40 by volume. Higher or lesser ratios of water to hydrophobic extraction medium may be used to optimize extraction conditions, extraction yield, and quality of the crude extraction product.

The disclosed extraction method may optionally include the addition of a water soluble carbohydrate to the extraction mixture. The use of carbohydrates in the extraction mixture reduce reverse micelle formation and improves the overall quality and purity of the crude extraction product.

The water soluble carbohydrate may be added to the water of the method prior to adding the water to the extraction mixture or the carbohydrate may be added at a later point in the extraction mixture. Suitable carbohydrates may be water soluble saccharides, disaccharides, polysaccharides, or large water soluble carbohydrates. Examples of suitable carbohydrates for the disclosed method include: dextrose, glucose, sucrose, fructose, galactose, maltose, lactose, glycogen, water soluble starches, and other water soluble saccharide based polymers. Glucose, dextrose, and sucrose being examples of preferred carbohydrates for use in the extraction method. The amount of carbohydrate may range from 0.1 M in the water portion of the extraction mixture up to the saturation level of the carbohydrate in the water portion of the extraction mixture. Preferred concentrations of carbohydrate in the water portion of the extraction mixture are 0.5 M to the saturation of point of the carbohydrate in the water of the extraction mixture. An even more preferred concentration of the carbohydrate in the water portion of the extraction mixture is between 50% and 100% of the saturation point of the carbohydrate in the water portion of the extraction mixture.

The disclosed extraction method may optionally include the addition of an antioxidant. The antioxidant may be added at any step in the extraction method or may be an additional step to the extraction method. Addition of an antioxidant typically improves the overall yield and quality of the crude essential oil extract. Generally, antioxidants protect against oxidation of the essential oil extract that can occur and which is more likely to occur when the essential oil extract is in contact with water and/or when the essential oil extract is heated. This results in degradation of the essential oil extract and contamination of the essential oil extract with oxidative byproducts. Therefore, addition of an antioxidant reduces the likelihood of this occurring. Any number of suitable antioxidant compounds, which are known in the art, may be used, such as, for example, tocopherol and tocopherol derivatives.

The disclosed extraction method may optionally include the addition of a pH buffer. The pH buffer may be premixed with the water of extraction method or may be an additional aqueous solution added to the extraction mixture. Use of a pH buffer adds the ability to control the pH of the aqueous portion of the extraction method. Depending on the particular essential oil to be extracted, control of the pH of the aqueous portion of the extraction mixture can increase extraction efficiency, reduce degradation of the essential oil extract during the extraction process, and reduce triglyceride hydrolysis. For example, triglyceride hydrolysis is less likely to occur in the extraction mixture when the pH of the aqueous portion of the extraction mixture is at or near a pH of 7. Many pH buffers known in the art may be used for this purpose. Non-limiting examples of suitable buffers are TRIS (tris(hydroxymethyl)aminomethane); HEPES (4-(2-hydroxyethyl)-1-piperazineethanesulfonic acid); acetic acid based pH buffers; and phosphate based pH buffers. But many more pH buffers are known in the art that are suitable for use in the disclosed extraction method.

The preferred pH of the extraction medium may vary depending on the plant to be extracted and the chemical nature of the desired extracts. For example, low pH, typically in the range of pH 2-4 is desired for essential oils containing carboxylic acids because this pH range reduces the solubility of carboxylic acids in water. But, basic pH ranges, such as from pH 8-11, typically result in purer final extraction products because basic pH ranges increase the solubility of undesired by products in water.

Because plant essential oils, there terpene, and terpenoid like components generally are very similar in there chemical nature regardless of the plant to be extracted, the disclosed method of extraction may be used for extraction of essential oils from a wide variety of plants. Non-limiting examples of plants that may be used in the disclosed extraction method include: mints; herbs: spices; roots; coffea; cacao; plants with fragrant flowers or leaves; etc. In addition the extraction method may be used on plants that have essential oils that can be used for medicinal purposes, flavoring purposes, fragrance purposes, etc.

A couple illustrative, non-limiting examples follow.

### EXAMPLE 1

The method of one embodiment was used to prepare crude boxwood brush leaf essential oil extract as follows: 30 ml of a 40% isopropanol/60% water solution was added to a 50 ml conical tube. 5 grams of ground boxwood brush leaves was added to the isopropanol/water solution. The resulting mixture was agitated by benchtop vortexer for 15 minutes at 2000 rpm. 5 grams magnesium sulfate and 3 grams sodium chloride was added to the extraction mixture. The resulting mixture was agitated by benchtop vortexer at 2000 rpm until phase separation between the water and isopropanol occurred. The isopropanol layer was removed from the water layer. Any remaining plant material was removed from the isopropanol layer by filtration. The remaining isopropanol was removed by heating the resulting solution to at least the boiling point of isopropanol until all isopropanol was evaporated, leaving crude boxwood brush leaf extract.

### EXAMPLE 2

The method of one embodiment was used to prepare crude boxwood brush leaf essential oil extract as follows: 200 ml of purified water was added to a 1 liter glass cylinder. Sufficient dextrose was added into the water with agitation to saturate the water with dextrose. 200 ml of vegetable oil was added to the saturated dextrose solution. 20 grams of boxwood brush leaves were added to the resulting mixture. The resulting mixture was heated to 80° C. and maintained around 80° C. without agitation for 15 minutes. The mixture was briefly mixed and then maintained around 80° C. without further agitation for 30 minutes. The extraction mixture was then cooled with an ice water bath. Upon sufficient cooling, plant material was removed from the mixture by filtration. The water was removed from the extraction mixture. The remaining extraction mixture, containing the vegetable oil and the essential oil extraction products, was then subjected to vacuum distillation to remove the crude essential oil extraction product from the vegetable oil.

What is claimed is:

1. A method for extraction of essential oil from plant material comprising:
combining plant material with a hydrophobic extraction medium and water to form an extraction mixture, wherein the boiling point of the hydrophobic extraction medium is greater than the boiling point of essential oil to be extracted from the plant material;
separating the plant material from the extraction mixture after sufficient time for extraction of plant essential oils;
separating the aqueous portion of the extraction mixture from the hydrophobic extraction medium; and
separating the crude essential oil extract from the hydrophobic extraction medium.

2. The method of claim 1, wherein the hydrophobic extraction medium comprises a lipid.

3. The method of claim 2, wherein the lipid comprises at least one of a fat and oil.

4. The method of claim 3, wherein the fat or oil comprises a cooking oil.

5. The method of claim 3, wherein the at least one of the fat and oil is at least one of vegetable oil, safflower oil, peanut oil, olive oil, lard, olive oil, coconut oil, palm oil, and corn oil.

6. The method of claim 1, wherein the water portion of the extraction mixture is pH buffered.

7. The method of claim 1, wherein the water portion of the extraction mixture contains a carbohydrate.

8. The method of claim 7, wherein the carbohydrate comprises at least one of a monosaccharide, disaccharide, and a polysaccharide.

9. The method of claim 8, wherein the carbohydrate is dextrose.

10. The method of claim 1, comprising the additional step of heating the extraction mixture.

11. The method of claim 1, comprising the additional step of agitating the extraction mixture.

12. The method of claim 1, wherein the crude essential oil extract is separated from the hydrophobic extraction medium by distillation.

13. The method of claim 12, wherein the distillation comprises a vacuum distillation.

14. The method of claim 1, wherein the separated crude essential oil extract is purified after separation from the hydrophobic extraction medium.

15. A method for extraction of essential oil from plant material comprising:
combining a plant material with a solution of a water miscible solvent and water to form an extraction mixture;
removing the plant material from the extraction mixture after sufficient time for extraction of plant essential oils;
adding a salt or a carbohydrate to the extraction mixture so that the water and the water miscible solvent become immiscible;
separating the water from the water miscible solvent, the separated water miscible solvent containing a crude essential oil extract; and
separating the crude essential oil extract from the water miscible solvent.

16. The method of claim 15, wherein the water miscible solvent is at least one of acetic acid, acetone, acetonitrile, t-butyl alcohol, diethylene glycol dimethyl ether, dimethylformamide, dimethyl sulfoxide, 1,4-dioxane, ethanol, ethylene glycol, glycerin, methanol, 1-propanol, 2-propanol, and pyridine.

17. The method of claim 15, wherein the salt comprises a water soluble salt containing at least one of an alkaline metal anion, alkaline earth metal anion, and a polyatomic anion.

18. The method of claim 15, wherein the salt comprises a water soluble salt containing at least one of halide cation and a polyatomic cation.

19. The method of claim 15, wherein the carbohydrate is at least one of a monosaccharide, a disaccharide, and a polysaccharide.

20. The method of claim 19, wherein the at least one of the monosaccharide, the disaccharide, and the polysaccharide comprises at least one of glucose, sucrose, fructose, galactose, maltose, lactose, glycogen, a water soluble starch, and a water soluble saccharide based polymer.

21. The method of claim 15, wherein the extraction mixture is pH buffered.

22. The method of claim 15, comprising the additional step of heating the extraction mixture.

23. The method of claim 15, comprising the additional step of agitating the extraction mixture.

24. The method of claim 15, wherein the crude essential oil extract is separated from the water miscible solvent by distillation.

25. The method of claim 15, wherein the crude essential oil extract is separated from the water miscible solvent by evaporation of the water miscible solvent.

26. The method of claim 15, wherein the separated crude essential oil extract is purified after separation from the water miscible solvent.
